(19) United States
(12) Patent Application Publication
(10) Pub. No.: US 2022/0134339 A1
(43) Pub. Date: May 5, 2022

(54) BIOSENSOR

(71) Applicant: PHC HOLDINGS CORPORATION, Tokyo (JP)

(72) Inventors: Nao HAYASHINO, Ehime (JP); Shingo OOTANI, Ehime (JP)

(21) Appl. No.: 17/431,032

(22) PCT Filed: Feb. 10, 2020
(86) PCT No.: PCT/JP2020/005046

§ 371 Date: Aug. 13, 2021

(30) Foreign Application Priority Data
Feb. 15, 2019 (JP) 2019-026105

(51) Int. Cl. B01L 3/00

(52) U.S. Cl. CPC B01L 3/502746; B01L 2200/027; B01L 2200/14; B01L 2400/0406; B01L 2300/041; B01L 2300/0645; B01L 2200/16

(57) ABSTRACT

A biosensor includes: a base plate; an electrode layer located on a major surface of the base plate and including a first electrode pair; a spacer plate provided on the electrode layer, the spacer plate having a first opening and at least one partition located in the first opening and connected with a periphery of the first opening at one end so as to divide part of the first opening into two or more portions; a first reagent layer provided in each of the two or more portions of the first opening; and a cover plate having an entrance section including at least one entrance opening and provided on the spacer plate, the entrance section overlapping at least part of the first opening, wherein part of the first electrode pair is located in the two or more portions of the first opening of the spacer plate.

### TECHNICAL FIELD

The present application relates to a biosensor for measuring the concentration of a specific substance contained in a specimen.

### BACKGROUND ART

Biosensors have been put into practical use in various fields including the fields of medical and clinical examinations and pharmaceutical fields. For example, biosensors for measurement of the concentration of various substances in blood have been put into practical use and widely used in the fields of medical and clinical examinations.

Patent Document No. 1 discloses a sensor with microchannels which can be used as an electrochemical blood test strip for blood clotting measurement or the like. This microfluidic sensor has a channel which has branches through which a fluid under measurement is caused to flow by capillary action and an electrode pair provided in reaction zones located at the terminal ends of the two branched channels. Patent Document No. 2 discloses a biosensor which includes a filter for filtering a specimen at the entrance side.

### CITATION LIST

### Patent Literature

Patent Document No. 1: Japanese Patent Publication No. 2015-108622

Patent Document No. 2: Japanese Patent Publication No. 2002-202283

### SUMMARY OF INVENTION

### Technical Problem

Some biosensors are required to have higher measurement accuracy. The present disclosure provides a biosensor which can achieve high measurement accuracy.

### Solution to Problem

A biosensor of one embodiment of the present disclosure includes: a base plate having a major surface; a cover plate having an entrance section including at least one entrance opening; at least one partition located in the first measurement space so as to divide part of the first measurement space into two or more portions; at least one electrode layer located between the base plate or the cover plate and the first measurement space, the electrode layer including a first electrode pair including a working electrode and a counter electrode, part of the first electrode pair being located in the two or more portions of the first measurement space; and a first reagent layer containing a first reagent capable of reacting with a specimen, the first reagent layer being located in the two or more portions of the first measurement space.

### Advantageous Effects of Invention

According to a biosensor of the present disclosure, the probability of formation of bubbles in a space where a specimen is to be held is suppressed, and therefore, it is possible to detect a specific substance with high measurement accuracy.

### BRIEF DESCRIPTION OF DRAWINGS

FIG. 1A is a perspective view showing an embodiment of a biosensor.

FIG. 1B is a perspective exploded view of the biosensor shown in FIG. 1A.

FIG. 2A is a plan view of the biosensor shown in FIG. 1A.

FIG. 2B is a cross-sectional view of the biosensor taken along line 2B-2B of FIG. 2A.

FIG. 2C is another cross-sectional view of the biosensor taken along line 2C-2C of FIG. 2A.

FIG. 2D is a plan view of the biosensor shown in FIG. 1A from which a cover plate has been removed.

FIG. 2E is a plan view of the biosensor shown in FIG. 1A from which a cover plate and first and second reagent layers have been removed.

FIG. 2F is a plan view of the biosensor shown in FIG. 1A from which a cover plate, first and second reagent layers and a spacer plate have been removed.

FIG. 3 is a block diagram showing the configuration of a measurement device.

FIG. 4 is a perspective view showing dropping of a specimen onto a biosensor.

FIG. 5A is a schematic diagram illustrating introduction of a specimen into the first measurement space with a partition.

FIG. 5B is a schematic diagram illustrating introduction of a specimen into the first measurement space with a partition.

FIG. 5C is a schematic diagram illustrating introduction of a specimen into the first measurement space with a partition.

FIG. 5D is a schematic diagram illustrating introduction of a specimen into the first measurement space with a partition.

FIG. 5E is a schematic diagram illustrating introduction of a specimen into the first measurement space with a partition.

FIG. 6A is a schematic diagram illustrating introduction of a specimen into the first measurement space without a partition.

FIG. 6B is a schematic diagram illustrating introduction of a specimen into the first measurement space without a partition.

FIG. 6C is a schematic diagram illustrating introduction of a specimen into the first measurement space without a partition.

FIG. 6D is a schematic diagram illustrating introduction of a specimen into the first measurement space without a partition.

FIG. 6E is a schematic diagram illustrating introduction of a specimen into the first measurement space without a partition.

FIG. 7A is a schematic diagram showing another form of the biosensor.

FIG. 7B is a schematic diagram showing another form of the biosensor.

FIG. 7C is a schematic diagram showing another form of the biosensor.

FIG. 7D is a schematic diagram showing another form of the biosensor.

FIG. 7E is a schematic diagram showing another form of the biosensor.

FIG. 7F is a schematic diagram showing another form of the biosensor.

FIG. 8A is a plan view showing a cover plate for use in another form of the biosensor.

FIG. 8B is a plan view showing an electrode layer for use in another form of the biosensor.

FIG. 8C is a plan view showing a base plate for use in another form of the biosensor.

FIG. 9A is a plan view showing a second electrode layer for use in another form of the biosensor.

FIG. 9B is a plan view showing a spacer plate for use in another form of the biosensor.

FIG. 9C is a plan view showing a first electrode layer for use in another form of the biosensor.

FIG. 10A is a plan view showing a spacer plate for use in another form of the biosensor.

FIG. 10B is a plan view showing a partition for use in another form of the biosensor.

### DESCRIPTION OF EMBODIMENTS

A biosensor including microchannels moves a specimen using capillary force. In measuring the concentration of a specific substance using the biosensor with high accuracy, it is preferred that the same measurement conditions are reproduced for every measurement. The inventors of the present application closely studied the process in a biosensor, from introduction of a specimen to electrochemical measurement, and found that when the space for holding the specimen is large the capillary force largely acts along the periphery of the space and therefore the specimen moves faster in the peripheral part than in the central part of the space, so that the central part of the space is not sufficiently filled with the specimen and bubbles can be formed in some cases. When such bubbles are formed, for example, the space is not thoroughly filled with the specimen and therefore the amount of the specimen to be measured can vary. When a reagent is provided in the space, part of the reagent is covered with bubbles and fails to react with the specimen, so that the reaction amount of the reagent can vary. These factors can affect the measurement accuracy.

For example, electrochemically measuring the value of hemoglobin A1c (hereinafter, referred to as “HbA1c”) using a biosensor is now discussed. The HbA1c value is a test value represented by the proportion of hemoglobin bonded with sugar (HbA1c) to the hemoglobin in red blood cells (referred to as “Hb”). Since the HbA1c value reflects the average blood sugar level in the last 1-2 months, the HbA1c value is unlikely to be affected by food eaten before the test and can be used as a more precise index for management of diabetes as compared with the blood glucose level. The HbA1c value cannot be determined without determining the concentration (amount) of HbA1c and the concentration (amount) of Hb. Herein, Hb means the total Hb that includes HbA1c and other derivatives. However, the concentration of HbA1c is low in general and, therefore, it is particularly difficult to electrochemically measure the concentration of HbA1c. Thus, conventionally, mainly the HbA1c value is measured by optical spectroscopy.

Measurement of the HbA1c value with the use of an electrochemical measurement method can be realized by increasing the amount of the specimen used as much as possible and increasing the detection area in the electrodes such that the detection accuracy can be increased. To this end, it is necessary to enlarge the space for holding the specimen. However, as previously described, if the space for holding the specimen is enlarged, bubbles are likely to be formed, and decrease in measurement accuracy can occur.

In view of the above-described problems, the inventors of the present application arrived at a biosensor which has a novel configuration. Outlines of the biosensor of the present disclosure are as follows.

[Item 1]

A biosensor comprising:

a base plate having a major surface;

a cover plate having an entrance section including at least one entrance opening;

a first measurement space located between the base plate and the cover plate, the first measurement space being in communication with the entrance opening of the cover plate;

at least one partition located in the first measurement space so as to divide part of the first measurement space into two or more portions;

at least one electrode layer located between the base plate or the cover plate and the first measurement space, the electrode layer including a first electrode pair including a working electrode and a counter electrode, part of the first electrode pair being located in the two or more portions of the first measurement space; and

a first reagent layer containing a first reagent capable of reacting with a specimen, the first reagent layer being located in the two or more portions of the first measurement space.

[Item 2]

The biosensor as set forth in Item 1, wherein the first measurement space and the at least one partition are elongated in the first direction, and the two or more portions of the measurement space have generally equal widths in a second direction that is perpendicular to the first direction.

[Item 3]

The biosensor as set forth in Item 2, further comprising a spacer plate having a first opening which defines the first measurement space, the spacer plate being located between the base plate and the cover plate.

[Item 4]

The biosensor as set forth in Item 3, wherein the at least one partition is located in the first opening of the spacer plate, one end of the partition being connected with a periphery of the first opening.

[Item 5]

The biosensor as set forth in Item 3, wherein the partition is a single partition.

[Item 6]

The biosensor as set forth in Item 3, wherein the partition is two partitions.

[Item 7]

The biosensor as set forth in any of Items 3 to 6, wherein at least part of the entrance section of the cover plate overlaps another part of the first opening of the spacer plate.

[Item 8]

The biosensor as set forth in any of Items 3 to 6, wherein at least part of the entrance section of the cover plate overlaps each of the two or more portions of the first opening of the spacer plate.

[Item 9]

The biosensor as set forth in any of Items 3 to 8 wherein, in a plan view, the other end of the at least one partition is tapered.

[Item 10]

The biosensor as set forth in any of Items 3 to 8 wherein, in a plan view, the other end of the at least one partition has a semicircular or curved shape.

[Item 11]

11. The biosensor as set forth in any of Items 3 to 10 wherein, in a plan view, one end of the at least one partition has a curved portion in a part connecting to the periphery of the first opening.

[Item 12]

The biosensor as set forth in Item 3, wherein the base plate, the spacer plate and the cover plate have a longitudinal direction in the first direction.

[Item 13]

The biosensor as set forth in Item 12, wherein a length in the first direction of the at least one partition is greater than a width in the second direction of the base plate, the spacer plate and the cover plate.

[Item 14]

The biosensor as set forth in any of Items 3 to 13, wherein

the electrode layer is a single electrode layer, and

the electrode layer is located between the base plate and the spacer plate.

[Item 15]

The biosensor as set forth in any of Items 3 to 13, wherein

the electrode layer is a single electrode layer, and

the electrode layer is located between the cover plate and the spacer plate.

[Item 16]

The biosensor as set forth in any of Items 3 to 13, wherein

the at least one electrode layer includes a first electrode layer and a second electrode layer,

the first electrode layer is located between the base plate and the spacer plate,

the second electrode layer is located between the cover plate and the spacer plate,

the first electrode layer includes one of the working electrode and the counter electrode, and

the second electrode layer includes the other of the working electrode and the counter electrode.

[Item 17]

The biosensor as set forth in any of Items 3 to 16, further comprising a second reagent layer containing a second reagent capable of reacting with the specimen,

wherein the spacer plate has a second opening which is independent of the first opening and which defines a second measurement space,

the electrode layer further includes a second electrode pair including a working electrode and a counter electrode,

part of the second electrode pair is located in the second opening,

the second reagent layer is located in the second opening, and

another part of the entrance section overlaps the second opening.

[Item 18]

The biosensor as set forth in any of Items 3 to 17, wherein the cover plate has a first evacuation hole in communication with the first opening of the spacer plate, the first evacuation hole and the entrance section being located at opposite ends in the first direction of the first opening.

[Item 19]

The biosensor as set forth in Item 17, wherein

the cover plate has a first evacuation hole in communication with the first opening of the spacer plate and a second evacuation hole in communication with the second opening,

the first evacuation hole and the entrance section are located at opposite ends in the first direction of the first opening, and

the second evacuation hole and the entrance section are located at opposite ends in the first direction of the second opening.

[Item 20]

The biosensor as set forth in any of Items 1 to 19, wherein the first reagent layer is capable of reacting with an identical substance derived from the specimen.

[Item 21]

The biosensor as set forth in any of Items 1 to 20, wherein

the specimen includes hemoglobin separated from a red blood cell,

the hemoglobin includes hemoglobin A1c, and

the first reagent is capable of specifically reacting with the hemoglobin A1c or a substance derived from the hemoglobin A1c.

[Item 22]

The biosensor as set forth in Item 17 or 19, wherein

the specimen includes hemoglobin separated from a red blood cell,

the hemoglobin includes hemoglobin A1c,

the first reagent is capable of specifically reacting with the hemoglobin A1c or a substance derived from the hemoglobin A1c, and

the second reagent is capable of reacting with the hemoglobin.

Hereinafter, an embodiment of the biosensor of the present disclosure is described in detail with reference to the drawings. The biosensor of the present disclosure is capable of electrochemically detecting and/or quantifying two different specific substances contained in a specimen. For example, a form of the biosensor for detecting the first substance and the second substance contained in a specimen is described. Particularly when the detection sensitivities of two or more substances contained in a specimen are different, the biosensor of the present disclosure is capable of detecting even a specific substance of relatively-low detection sensitivity with increased sensitivity. In the embodiment described in the following section, a biosensor for electrochemically measuring the concentrations of HbA1c and Hb in a specimen of pretreated blood as the first substance and the second substance will be described as an example. However, the biosensor of the present disclosure can also be suitably used for detection of other substances. As will be described later, the biosensor of the present disclosure can be suitably used when a relatively-large space is filled with a specimen for detecting and/or quantifying a specific substance with high accuracy.

The embodiment described in the following section is merely exemplary. The present invention is not limited to the embodiment. In the description of the embodiment in the following section, for the sake of understandability, or for the sake of avoiding unnecessary repetition, reference numerals are sometimes provided in the drawings so that repetitious descriptions can be omitted, or elements which are not mentioned in the description are sometimes not provided with reference numerals.

<Configuration of Biosensor>

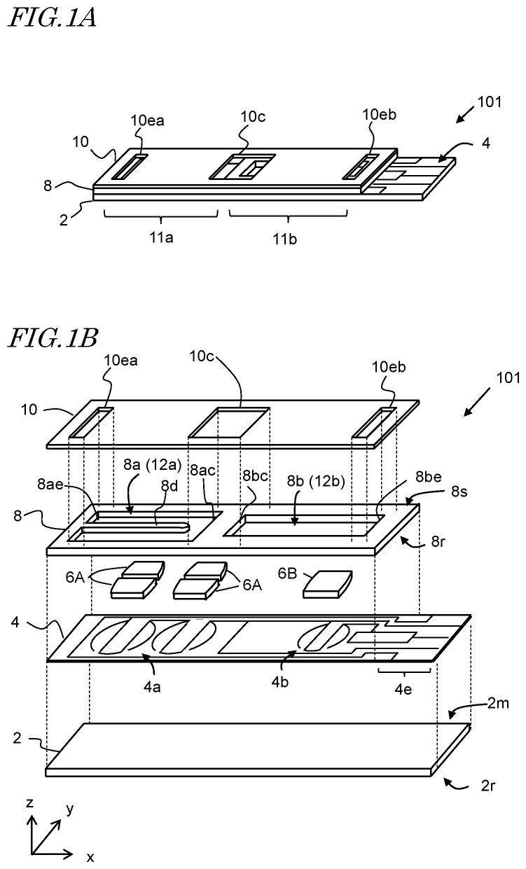

An embodiment of the biosensor of the present disclosure is described. FIG. 1A and FIG. 1B are a perspective view and a perspective exploded view of the biosensor 101 of the present embodiment. The biosensor 101 at least includes a base plate 2, a cover plate 10, a first measurement space 12a located between the base plate 2 and the cover plate 10 for detecting a specific substance contained in a specimen, a partition 8d, an electrode layer 4 located between the base plate 2 or the cover plate 10 and the first measurement space 12a, and a first reagent layer 6A. In the form shown in FIG. 1A and FIG. 1B, the biosensor 101 includes a base plate 2, an electrode layer 4, first and second reagent layers 6A, 6B, a spacer plate 8 and a cover plate 10. As shown in FIG. 1B, the base plate 2, the spacer plate 8 and the cover plate 10 have, for example, a strip shape which has a longitudinal direction along x direction (first direction) and of which the length in x direction is greater than the length in y direction (width direction or second direction).

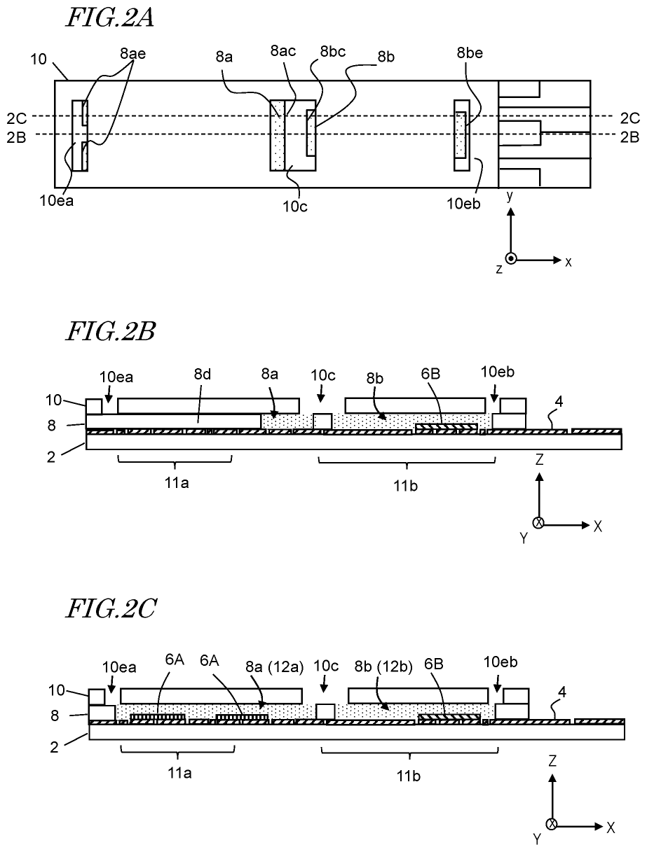

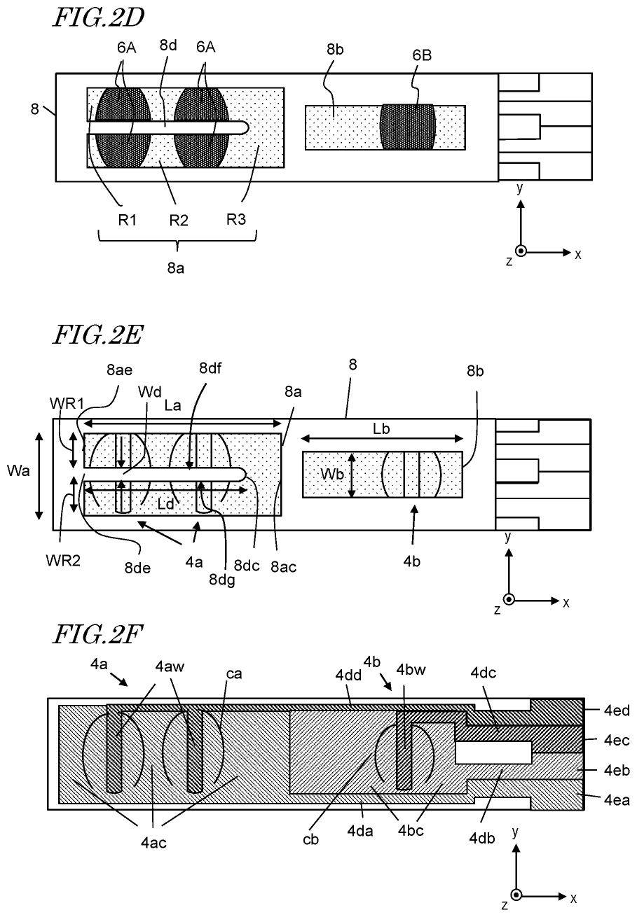

FIG. 2A is a plan view of the biosensor 101. FIG. 2B and FIG. 2C are cross-sectional views of the biosensor 101 taken along line 2B-2B and line 2C-2C of FIG. 2A. FIG. 2D, FIG. 2E and FIG. 2F are, respectively, a plan view of the biosensor 101 from which the cover plate 10 has been removed, a plan view of the biosensor 101 from which the cover plate 10 and the first and second reagent layers 6A, 6B have been removed, and a plan view of the biosensor 101 from which the components at higher levels than the spacer plate 8 have been removed. The configuration of the biosensor 101 is described in detail with reference to these drawings.

The base plate 2 supports the entire structure of the biosensor 101. The base plate 2 has a major surface 2m and a major surface 2r and has a strip shape as previously described. The major surfaces of the plate mean large major surfaces where the plate serves as a substrate for supporting components.

The biosensor 101 includes at least one electrode layer arranged so as to face the first measurement space 12a for detecting a specific substance of a specimen. In the present embodiment, as will be described later, the first measurement space 12a is defined by the spacer plate 8, and the biosensor 101 includes a single electrode layer 4 located between the base plate 2 and the spacer plate 8. The electrode layer 4 is located on the major surface 2m of the base plate 2. For the sake of understandability, in FIG. 2F, electrically-continuous parts of the electrode layer 4 are shaded. The electrode layer 4 at least includes a first electrode pair 4a and a second electrode pair 4b. The first electrode pair 4a and the second electrode pair 4b are used for detecting the first substance and the second substance, which are different substances in a specimen. In the present embodiment, the first substance is HbA1c, and the second substance is Hb.

As shown in FIG. 2F, the first electrode pair 4a includes working electrodes 4aw and counter electrodes 4ac. In the present embodiment, the first electrode pair 4a includes two working electrodes 4aw and three counter electrodes 4ac. The two working electrodes 4aw are coupled with a terminal 4ed via a wire portion 4dd. The three counter electrodes 4ac are coupled with a terminal 4ea via a wire portion 4da. In x direction that is the longitudinal direction of the base plate 2, the working electrodes 4aw and the counter electrodes 4ac are alternately arranged.

Likewise, the second electrode pair 4b includes a working electrode 4bw and a counter electrodes 4bc. In the present embodiment, the second electrode pair 4b includes a single working electrode 4bw and two counter electrodes 4bc. The working electrode 4bw is coupled with a terminal 4ec via a wire portion 4dc. The two counter electrodes 4bc are coupled with a terminal 4eb via a wire portion 4db. In the longitudinal direction of the base plate 2, the working electrode 4bw and the counter electrodes 4bc are alternately arranged. A pair of counter electrodes 4ac, between which each of the working electrodes 4aw is interposed, have cuts ca in the shape of an elliptical arc. Likewise, a pair of counter electrodes 4bc, between which the working electrode 4bw is interposed, have cuts cb in the shape of an elliptical arc.

In the present embodiment, the configuration of the above-described electrodes in the electrode layer 4 is realized by patterning a metal film continuously covering an approximate entirety of the major surface 2m of the base plate 2.

The spacer plate 8 is provided on the electrode layer 4. In the present embodiment, the spacer plate 8 includes a first opening 8a and a second opening 8b. The length in the longitudinal direction of the spacer plate 8 is smaller than the length of the base plate 2. Therefore, the terminals 4ea-4ed of the electrode layer 4 are not covered with the spacer plate 8 but exposed. The first opening 8a and the second opening 8b define the first measurement space 12a and the second measurement space 12b for measuring different specific substances of a specimen.

The first opening 8a and the second opening 8b are through holes reaching two major surfaces 8s, 8r of the spacer plate 8. The first opening 8a and the second opening 8b are independent spaces and are not in communication with each other. The spacer plate 8 is interposed between the base plate 2 and the cover plate 10 such that the first opening 8a and the second opening 8b serve as reaction chambers where a specimen is to be held and the electrical change in the specimen which can be caused by the reaction of the specimen with the first and second reagent layers 6A, 6B is to be detected.

The first opening 8a and the second opening 8b each have, for example, a rectangular shape which is longitudinal along the longitudinal direction of the spacer plate 8 and are arranged along the longitudinal direction of the spacer plate 8. Thus, in the vicinity of the center of the spacer plate 8, the edge 8ac of the first opening 8a is close to the edge 8bc of the second opening 8b. The edge 8ae of the first opening 8a and the edge 8be of the second opening 8b are respectively close to the opposite ends in the longitudinal direction of the spacer plate 8.

In the present embodiment, the first substance in the specimen held in the first opening 8a is detected with high sensitivity. That is, the volume of the reaction chamber for detecting the first substance is greater than the volume of the reaction chamber for detecting the second substance. Thus, preferably, the area of the first opening 8a is greater than the area of the second opening 8b. In the present embodiment, as shown in FIG. 2E, for example, La>Lb holds and Wa>Wb also holds where La and Lb are the lengths in x direction (the longitudinal direction) of the first opening 8a and the second opening 8b and Wa and Wb are the widths in y direction (the direction perpendicular to the longitudinal direction) of the first opening 8a and the second opening 8b. This enables the amount of the specimen which can be held in the first opening 8a to be greater than the amount of the specimen which can be held in the second opening 8b. La is, for example, 15 mm to 25 mm and, in one example, about 18.6 mm.

The size of the first opening 8a and the second opening 8b can be determined according to the amount of the specimen which is required in consideration of the concentration of the first substance and the second substance in the specimen, the detection sensitivity in a detection method used, etc. When capillary force is used to introduce the specimen into the first opening 8a and the second opening 8b, the spacer plate 8 has such a thickness (z direction) that the capillary force can act on the specimen. For example, the thickness of the spacer plate 8 is 0.01 mm to 1 mm and, in one example, 0.15 mm.

In the form shown in FIG. 1A and FIG. 1B, the spacer plate 8 includes at least one partition located in the first opening 8a. An end of the at least one partition is connected with the periphery of the first opening 8a such that part of the first measurement space 12a defined by the first opening 8a is divided into two or more portions. In the present embodiment, the spacer plate 8 includes a partition 8d. The partition 8d is elongated in x direction. The longitudinal end 8de of the partition 8d is connected with the edge 8ae of the first opening 8a.

The length in x direction of the partition 8d, Ld, is shorter than the length in x direction of the first opening 8a, La. The width in y direction of the partition 8d, Wd, is sufficiently shorter than the width in y direction of the first opening 8a, Wa.

The partition 8d divides the first opening 8a in y direction into the first portion R1 and the second portion R2. The first portion R1 and the second portion R2 are each in communication with the third portion R3 in which the partition 8d is not present. The width WR1 of the first portion R1 and the width WR2 of the second portion are generally equal. Each of WR1 and WR2 is, for example, 2.5 mm to 5.5 mm and, in one example, about 3.25 mm.

As will be described later, in the third portion R3 of the first opening 8a, an entrance opening 10c of the cover plate 10 is provided. Meanwhile, in the first portion R1 and the second portion R2, the first reagent layer 6A is provided. Movement of the specimen in the biosensor 101 is mainly realized by capillary force. Since the capillary force depends on the wettability (surface tension) of wall surfaces surrounding the first opening 8a with respect to the specimen that is liquid, when the space is partitioned into small portions, greater capillary force acts in the partitioned portions of the space, and a region can be further reduced in which the capillary force is unlikely to act and the moving speed of the specimen is small. Thus, in introducing the specimen, bubbles are unlikely to be formed. The partition 8d also functions as a pillar provided in the first opening 8a and supports the cover plate 10.

In the present embodiment, the end 8dc of the partition 8d has a semicircular shape in a plan view. The end 8dc may have a curved shape, such as arc shape, elliptical shape, etc., rather than the semicircular shape. The wall surface 8df and the wall surface 8dg of the partition 8d are continuously connected at the end 8dc without having a boundary therebetween. Since the tip end of the partition 8d has such a shape in a plan view, the specimen introduced from the third portion R3 diverges and smoothly flows into the first portion R1 and the second portion R2 without causing turbulence.

As shown in FIG. 2E, the spacer plate 8 is provided on the electrode layer 4 and, therefore, in the first opening 8a and the second opening 8b, part of the first electrode pair 4a and part of the second electrode pair 4b are exposed. More specifically, in each of the first portion R1 and the second portion R2 of the first opening 8a, part of the first electrode pair 4a is exposed. The electrical or electrochemical change in the specimen held in the first opening 8a and the second opening 8b can be detected by the first electrode pair 4a and the second electrode pair 4b. The total of the lengths of the boundaries between the working electrodes 4aw and the counter electrodes 4ac of the first electrode pair 4a is 4×WR1+4×WR2. In the second opening 8b, the total of the lengths of the boundaries between the working electrode 4bw and the counter electrodes 4bc of the second electrode pair 4b is 2×Wb. The total of the lengths of the boundaries between the working electrodes and the counter electrodes is greater in the first electrode pair 4a than in the second electrode pair 4b, so that the detection sensitivity of the first electrode pair 4a is higher.

The first reagent layer 6A and the second reagent layer 6B each contain a first reagent and a second reagent. The first reagent and the second reagent are capable of respectively reacting with the first substance and the second substance of the specimen, or with substances derived from the first substance and the second substance by a pretreatment, thereby causing an electrically-detectable change in the specimen. In the present embodiment, the first reagent is fructosyl peptide oxidase which is a detection enzyme capable of specifically reacting with fructosyl valyl histidine produced by pretreating Hb1Ac. The first reagent is immobilized to the first reagent layer. The second reagent is potassium ferricyanide which is a mediator capable of reacting with all of Hb including Hb1Ac. The second reagent is immobilized to the second reagent layer.

The first reagent layer 6A and the second reagent layer 6B are respectively provided in the first portion R1 and the second portion R2 of the first opening 8a and the second opening 8b of the spacer plate 8. More specifically, the first reagent layer 6A is located above the vicinity of the boundaries between the working electrodes 4aw and the counter electrodes 4ac of two first electrode pairs 4a exposed in the first portion R1 and the second portion R2 of the first opening 8a, and the second reagent layer 6B is located above the vicinity of the boundaries between the working electrode 4bw and the counter electrodes 4bc of the second electrode pair 4b. The first reagent layer 6A is separately provided in two regions of the first portion R1 and the second portion R2 of the first opening 8a, and the first reagent layer 6A provided in the two regions is capable of reacting with an identical substance derived from the specimen.

In the present embodiment, when the materials of the first reagent layer 6A and the second reagent layer 6B are dropped from above the electrode layer 4, the circular cuts ca, cb provided in the counter electrodes define the regions where the materials spread. Thus, the amount of the first reagent layer 6A and the amount of the second reagent layer 6B which are present in the vicinity of the boundaries between the working electrodes and the counter electrodes are constant, so that the variation of the electric current in detecting the first substance and the second substance among the biosensors can be suppressed.

The cover plate 10 is provided on the spacer plate 8. The cover plate 10 has an entrance section which includes at least one entrance opening. In the present embodiment, the entrance section has a single entrance opening 10c. As clearly shown in FIG. 2A and FIG. 2B, the entrance opening 10c overlaps part of the third portion R3 of the first opening 8a and part of the second opening 8b. More specifically, the edge 8ac at a longitudinal end of the first opening 8a and the edge 8bc at a longitudinal end of the second opening 8b are present in the entrance opening 10c. Thus, the entrance opening 10c is in communication with the third portion R3 of the first opening 8a and the second opening 8b. When the specimen is dropped to the entrance opening 10c, the specimen flows into the third portion R3 of the first opening 8a and the second opening 8b.

In the present embodiment, the cover plate 10 may further include a first evacuation hole 10ea and a second evacuation hole 10eb. The first evacuation hole 10ea and the second evacuation hole 10eb overlap part of the first opening 8a and part of the second opening 8b, respectively, and the edge 8ae of the first opening 8a and the edge 8be of the second opening 8b are present in the first evacuation hole 10ea and the second evacuation hole 10eb, respectively. Since the first evacuation hole 10ea and the second evacuation hole 10eb are provided, when the biosensor is configured such that capillary force acts on the first opening 8a and the second opening 8b, the air in these spaces is evacuated from the first evacuation hole 10ea and the second evacuation hole 10eb as the specimen is drawn into these spaces. Thus, it is possible to introduce the specimen into the first opening 8a and the second opening 8b by capillary force.

By stacking up the above-described components, the first cell 11a which includes the entrance opening 10c, the first opening 8a and the first evacuation hole 10ea and which is configured to detect the first substance and the second cell 11b which has the entrance opening 10c, the second opening 8b and the second evacuation hole 10eb and which is configured to detect the second substance are formed as shown in FIG. 1A and FIG. 2A.

The base plate 2, the spacer plate 8 and the cover plate 10 are made of an insulative material. For example, various resin materials, for example, PET (polyethylene terephthalate) resin or the like, can be used. Alternatively, these plates may be made of an inorganic material, such as glass. The electrode layer 4 is made of an electrically-conductive material. For example, the electrode layer 4 is formed by patterning a film of a metal such as palladium with a laser beam. The base plate 2, the electrode layer 4, the spacer plate 8 and the cover plate 10 are joined together using, for example, a thermosetting adhesive agent.

<Configuration of Measurement Device>

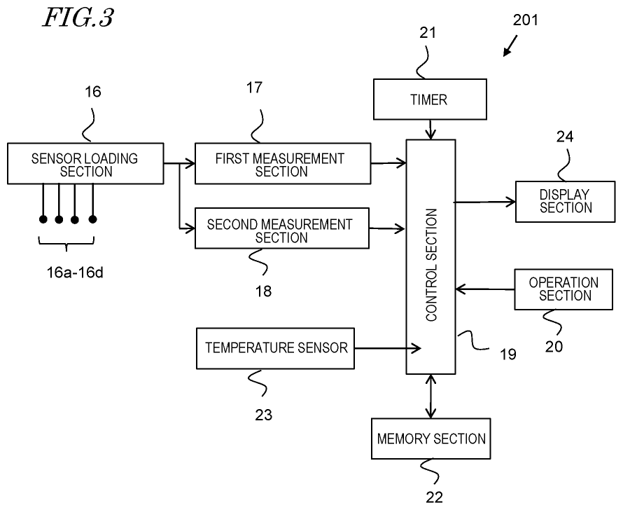

FIG. 3 shows a configuration example of a measurement device 201 loaded with the biosensor 101 for measurement of the first substance and the second substance of a specimen. The measurement device 201 includes a sensor loading section 16, a first measurement section 17, a second measurement section 18 and a control section 19. The sensor loading section 16 includes connectors 16a-16d which are in contact with the terminals 4ea-4ed of the biosensor 101 and which are electrically coupled with the first measurement section 17 and the second measurement section 18. The first measurement section 17 and the second measurement section 18 apply predetermined voltages to the first electrode pair 4a and the second electrode pair 4b, respectively, via the connectors 16a-16d and the terminals 4ea-4ed and measure current values. The measured current values are output to the control section 19.

The control section 19 determines the concentrations of the first substance and the second substance from the current values (or voltage values) received from the first measurement section 17 and the second measurement section 18. For example, the control section 19 has in its memory a table where current values and concentration values are related or a function of the current value and the concentration value and calculates the concentrations of the first substance and the second substance based on the table or function. In the present embodiment, the first substance is HbA1c, and the second substance is Hb. The control section 19 calculates the proportion of HbA1c to Hb from the current values or the concentration values and determines the HbA1c value. The measurement device 201 may further include an operation section 20, a timer 21, a memory section 22, a temperature sensor 23 and a display section 24 and may refer to the information from the temperature sensor 23 for correcting the HbA1c value. The corrected HbA1c value is stored in the memory section 22 together with the information regarding the time from the timer 21 and is meanwhile displayed on the display section 24. The control section 19 performs processes such as measurement, displaying, storing measurement results in the memory, etc., based on instructions entered by an operator from the operation section 20.

The control section 19 of the measurement device 201 includes an arithmetic unit, such as microcomputer, and a memory section. In the memory section, a program is stored which stipulates the procedure of the measurement. The arithmetic unit executes the program, thereby measuring the concentrations of the first substance and the second substance. The first measurement section 17 and the second measurement section 18 include a power supply circuit for generating a predetermined voltage and an ammeter for measuring the current value. The measured current value is converted to, for example, a digital signal and subjected to the above-described processes in the control section 19. The display section 24 may be a liquid crystal display device, an organic EL display device, or the like.

<Measurement of HbA1c with Biosensor 101 and Measurement Device 201>

Hereinafter, a specific measurement procedure of HbA1c with the use of the biosensor 101 and the measurement device 201 is described.

(1) Pretreatment on Specimen

Firstly, a blood specimen sampled from an examinee is pretreated. Specifically, a hemolytic agent such as surfactants is added to the sampled blood specimen such that Hb is eluted from red blood cells of the blood specimen.

Then, protease, which is a degrading enzyme, is added to the blood specimen containing the eluted Hb, whereby Hb is degraded. As a result of the degradation, HbA1c in the Hb produces fructosyl valyl histidine. Hereinafter, the pretreated blood specimen is simply referred to as “specimen”.

(2) Electrochemical Reaction in Biosensor 101

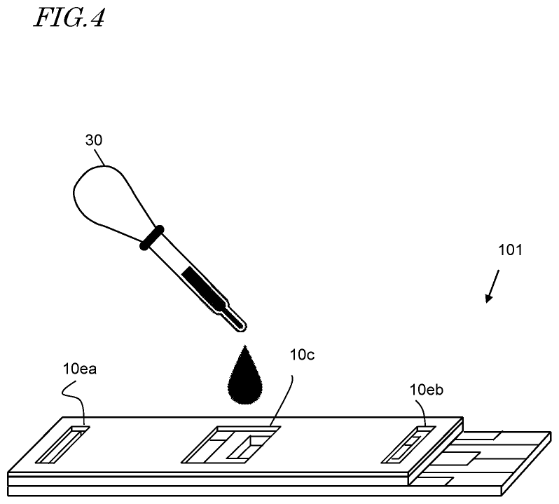

The biosensor 101 is put into the measurement device 201. The specimen is drawn into a dropper 30 and then dropped onto the vicinity of the entrance opening 10c of the biosensor 101 as shown in FIG. 4. The specimen placed on the vicinity of the entrance opening 10c is drawn in from the entrance opening 10c by capillary force and introduced into the first opening 8a and the second opening 8b concurrently, i.e., in parallel.

Fructosyl valyl histidine in the specimen introduced into the first opening 8a reacts with fructosyl peptide oxidase, which is the first reagent contained in the first reagent layer 6A, and produces hydrogen peroxide. The hydrogen peroxide produced in this reaction causes a reaction on the working electrodes 4aw so that an electric current which depends on the amount of the hydrogen peroxide flows between the working electrodes 4aw and the counter electrodes 4ac of the first electrode pair 4a. Since fructosyl valyl histidine is derived from HbA1c, the current value varies depending on the amount of HbA1c in the specimen.

Hb in the specimen introduced into the second opening 8b and potassium ferricyanide which is the second reagent contained in the second reagent layer 6B cause oxidation/reduction reactions. This transfer of electrons is detected as an electric current flowing between the working electrode 4bw and the counter electrodes 4bc of the second electrode pair 4b, whereby the current value which depends on the amount of Hb can be detected.

(3) Measurement with Measurement Device 201

For example, the measurement device 201 applies a voltage of 0.1 V to 0.4 V between the working electrodes 4aw and the counter electrodes 4ac of the first electrode pair 4a for 5 seconds to 10 seconds and measures the magnitude of an electric current flowing between the working electrodes 4aw and the counter electrodes 4ac. Likewise, the measurement device 201 applies a voltage of 0.1 V to 0.4 V between the working electrode 4bw and the counter electrodes 4bc of the second electrode pair 4b for 5 seconds to 10 seconds and measures the magnitude of an electric current flowing between the working electrode 4bw and the counter electrodes 4bc.

The current values measured by the first measurement section 17 and the second measurement section 18 are equivalent to the amount of HbA1c and the amount of Hb. The measurement device 201 uses these current values to determine the HbA1c value.

<Flow of Specimen in Biosensor>

According to a biosensor of the present embodiment, the partition 8d provided in the first opening 8a can suppress formation of bubbles in filling the first opening 8a with a specimen. Hereinafter, the effects achieved by provision of the partition 8d are described with reference to the drawings.

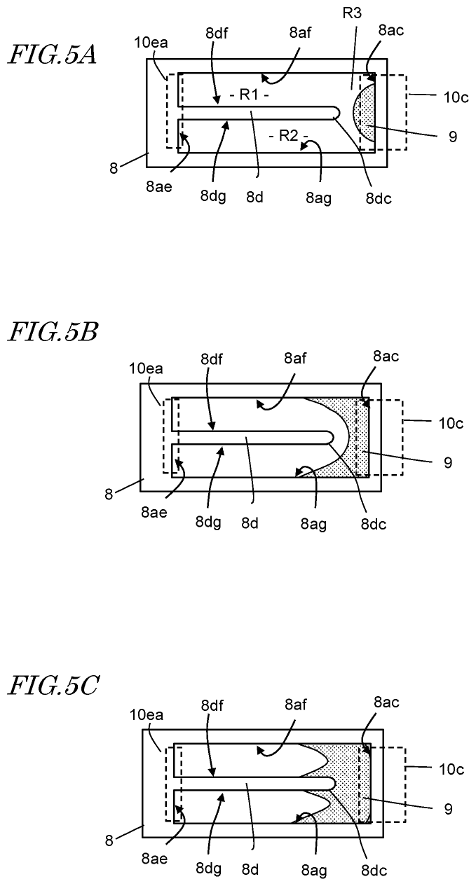

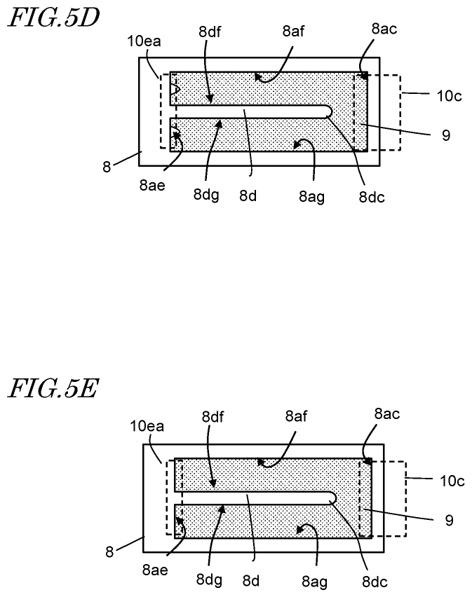

FIG. 5A, FIG. 5B, FIG. 5C, FIG. 5D and FIG. 5E are schematic diagrams showing the states of a specimen moving in the first opening 8a when the specimen is introduced from the entrance opening 10c in the biosensor 101 of the present embodiment. As previously described, introduction of the specimen into the first opening 8a and the second opening 8b is realized by capillary force. The capillary force relates to the wettability of wall surfaces which define a minute space with respect to liquid. In a region which is closer to the wall surfaces and which has a greater number of neighboring wall surfaces, greater capillary force acts.

As shown in FIG. 5A, a specimen 9 dropped from the entrance opening 10c first moves along the edge 8ac of the first opening 8a and reach the wall surfaces 8af, 8ag extending in the longitudinal direction, and then, the specimen 9 moves fast along the wall surfaces 8af, 8ag. Thus, as shown in FIG. 5B, a part of the specimen 9 near the center of the edge 8ac moves toward the edge 8ae slower than other parts of the specimen 9 near the wall surfaces 8af, 8ag. However, as shown in FIG. 5C, when the central part of the specimen 9 reaches the end 8dc of the partition 8d, it comes into contact with the wall surfaces 8df, 8dg of the partition 8d, so that strong capillary force acts, and the specimen 9 moves fast along the wall surfaces 8df, 8dg of the partition 8d. As a result, in the first portion R1 and the second portion R2 divided by the partition 8d, movement of the specimen 9 is largely delayed in a smaller region and, as shown in FIG. 5D, the specimen 9 as a whole moves toward the edge 8ae of the first opening 8a. As a result, as shown in FIG. 5E, the specimen 9 reaches the edge 8ae while the entirety of the first opening 8a is filled with the specimen 9. In this way, the first opening 8a is filled with the specimen 9 without bubbles left in the first opening 8a.

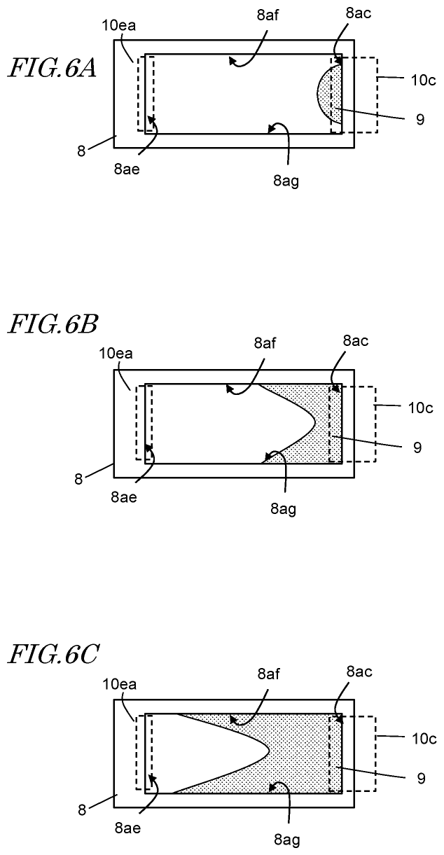

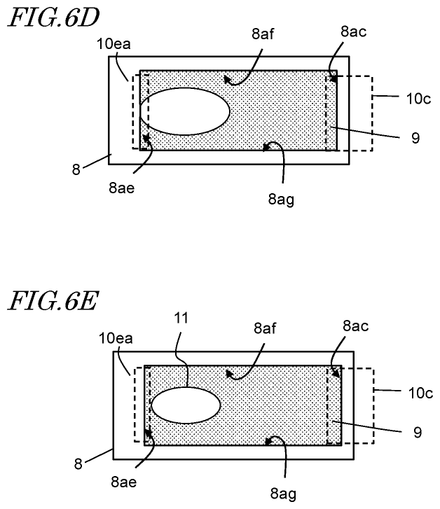

FIG. 6A, FIG. 6B, FIG. 6C, FIG. 6D and FIG. 6E are schematic diagrams illustrating movement of the specimen 9 in the first opening 8a in the case where the partition 8d is not provided in the first opening 8a. As shown in FIG. 6A, a specimen 9 dropped from the entrance opening 10c first moves along the edge 8ac of the first opening 8a and reach the wall surfaces 8af, 8ag extending in the longitudinal direction, and then, the specimen 9 moves fast along the wall surfaces 8af, 8ag. Thus, as shown in FIG. 6B, a part of the specimen 9 near the center of the edge 8ac moves toward the edge 8ae slower than other parts of the specimen 9 near the wall surfaces 8af, 8ag. As shown in FIG. 6C, when the partition 8d is not provided, a part of the specimen 9 near the center in the transverse direction of the first opening 8a always moves slower than other parts of the specimen 9 near the wall surfaces 8af, 8ag. As a result, as shown in FIG. 6D, when the specimen 9 reaches the edge 8ae near the wall surfaces 8af, 8ag, a part of the specimen 9 near the center in the transverse direction is far distant from the edge 8ae. The specimen 9 which has reached the edge 8ae near the wall surfaces 8af, 8ag then moves along the edge 8ae. As a result, as shown in FIG. 6E, the first evacuation hole 10ea is covered with the specimen 9. Therefore, a portion of the first opening 10a which is not filled with the specimen 9 appears as a bubble 11. The specimen 9 covering the first evacuation hole 10ea is unlikely to move due to surface tension which is attributed to contact with the edge 8ae. Thus, the bubble 11 is unlikely to be evacuated from the first evacuation hole 10ea.

<Effects>

According to the biosensor of the present disclosure, the partition 8d is provided in the first opening 8a. Therefore, when the specimen is introduced as previously described, no bubble is formed in the first opening 8a that serves as a reaction chamber, and the reaction chamber can be filled with the specimen. Thus, the amount of the specimen to be measured is unlikely to vary. Also, since the reagent is not partially covered with a bubble, the variation in the reaction amount of the reagent can be suppressed. Thus, according to the biosensor of the present disclosure, accurate measurement can be performed.

The partition 8d also functions as a supporting member provided in the first opening 8a. Therefore, when the area of the first opening 8a is increased, the partition 8d prevents the cover plate 10 from sagging toward the first opening 8a side. This prevents the volume of the first opening 8a from decreasing due to the sagging cover plate 10, so that a constant, accurate amount of the specimen can be measured.

In producing the biosensor 101, the process of stacking up the base plate, the electrode layer 4, the spacer plate 8, the first reagent layer 6A and the second reagent layer 6B, and the cover plate 10 and bonding together the spacer plate 8, the electrode layer 4 and the cover plate 10 by thermocompression bonding with heat and force applied from above the cover plate 10 is employed in some cases. In such a process, if the cover plate 10 deforms as previously described, there is a probability that the first reagent layer 6A provided in the first opening 8a and the cover plate 10 come into contact with each other, and the heat transfers from the cover plate 10 to the first reagent layer 6A, so that the first reagent contained in the first reagent layer 6A can degenerate or decompose due to the heat. According to the biosensor of the present disclosure, the partition 8d prevents sagging of the cover plate 10 as previously described and, therefore, transfer of the heat to the first reagent layer 6A due to such deformation of the cover plate 10 can be suppressed. Thus, occurrence of defective products in production of the biosensor 101 can be suppressed, and the production yield can be improved.

Since the entrance opening of the cover plate overlaps the first opening and the second opening, the specimen can be introduced into the first opening and the second opening in which the electrodes are provided without providing a branched channel for guiding the specimen to the reaction chamber. That is, the biosensor does not have a branched channel. Thus, by increasing the area of the first opening and/or the second opening, the amount of the specimen used for measurement can be increased, and the length of the boundary between the working electrode and the counter electrode can be increased, so that the detection sensitivity of the biosensor can be increased. Since, by introducing the specimen from the entrance section, the specimen can be concurrently introduced in parallel into the first opening and the second opening provided in the spacer plate, the time for filling the first opening and the second opening with the specimen before the start of measurement can be reduced.

In the first opening and the second opening, the specimen is brought into a reaction with the first substance and a reaction with the second substance, so that it is possible to detect or quantify two types of substances in the specimen using the first electrode pair and the second electrode pair. Since the first opening and the second opening are independent, one of the measurement of the first substance and the measurement of the second substance does not affect the other, and the two types of substances can be independently detected with high accuracy.

Since the first opening and the second opening are independent, the size of each of these openings can be arbitrarily set, and the amount of the specimen used can be independently adjusted. Thus, the amount of the specimen used can be changed according to the concentration and detection sensitivity of a substance to be detected in the specimen, and the measurement can be carried out with appropriate sensitivity. For example, by making the area of the first opening greater than the area of the second opening, the detection accuracy of a substance which is to be detected using the first substance can be improved. Further, by increasing the area of the first opening, the length of the boundary between the working electrode and the counter electrode in the first electrode pair can be increased, and the detection sensitivity can be further increased. Since the first opening and the second opening are independent, in introducing the specimen into the first opening and the second opening using capillary force, the capillary force which acts on each of the openings can be independently adjusted.

Since the entrance section is provided in the cover plate, the amount of the dropped specimen can be increased such that the first opening and the second opening can be filled with the specimen in a short time period, and the measurement time can be shortened. Also, even if the area of the first electrode pair and the second electrode pair for the detection is increased, a sufficient amount of the specimen can be brought into contact with the electrode pairs in a short time period. Thus, the detection sensitivity can be improved.

Since the first evacuation hole and the second evacuation hole are provided in the first opening and the second opening, respectively, the specimen can be introduced into the first opening and the second opening using capillary force. Thus, the first opening and the second opening can be stably and assuredly filled with the specimen.

<Other Forms>

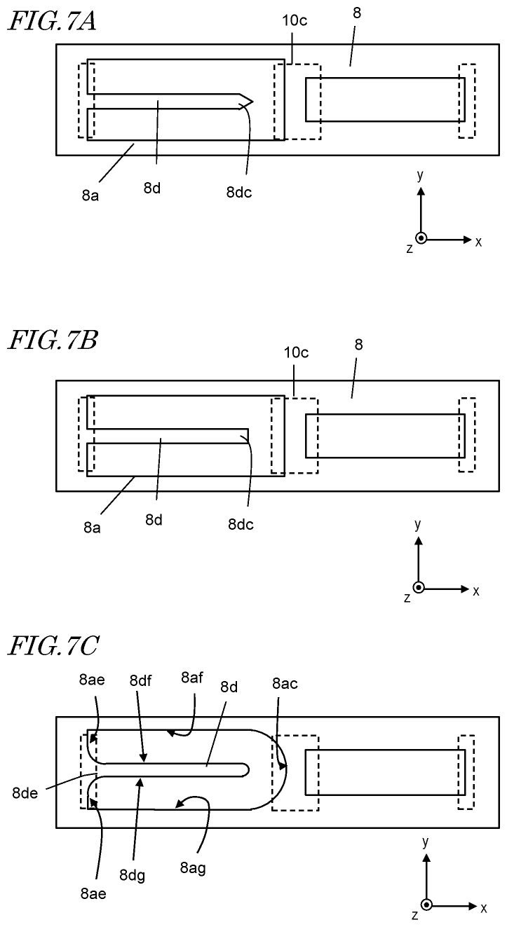

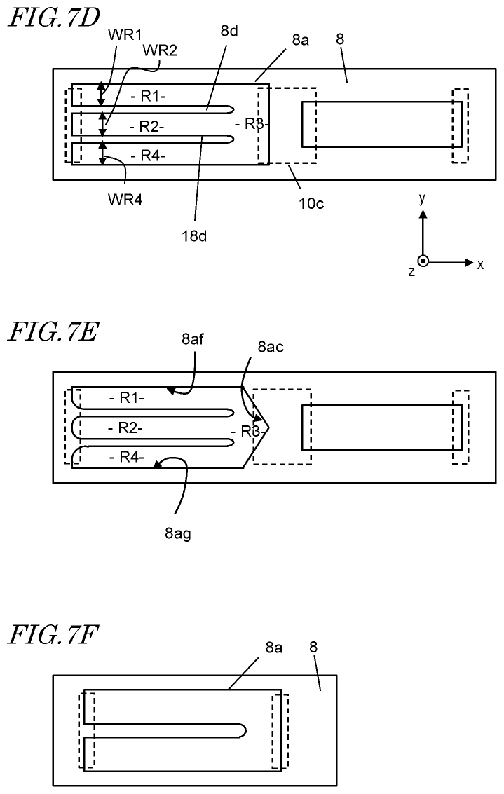

Various modifications to the biosensor of the present disclosure are possible. As shown in FIG. 7A and FIG. 7B, the end 8dc of the partition 8d may have such a tapered shape that, in a plan view, the width on the edge 8ac side of the first opening 8a is narrower. Alternatively, the partition 8d may have an end face which faces the edge 8ac of the first opening 8a.

As shown in FIG. 7C, the edge 8ae of the first opening 8a and the wall surfaces 8df, 8dg of the partition 8d, in a plan view, do not have clear boundaries but may be connected by curved surfaces. That is, the end 8de of the partition 8d may have curved portions in parts connecting to the periphery of the first opening 8a. Although not shown, likewise, the edge 8ae of the first opening 8a and the wall surfaces 8af, 8ag of the first opening 8a, in a plan view, do not have clear boundaries but may be connected by curved surfaces. When two wall surfaces are connected at a right angle in a plan view, there is a probability that a liquid spreading from one of the wall surfaces to the other will enclose bubbles due to the effects of the wettability of the wall surfaces. In this case, connecting the two wall surfaces by a curved surface can hinder formation of bubbles.

As shown in FIG. 7D, the spacer plate 8 may include two or more partitions provided in the first opening 8a. For example, the spacer plate 8 may include a partition 8d and a partition 18d. The partitions 8d, 18d are each elongated in x direction that is the longitudinal direction and are arranged in y direction that is the transverse direction, such that the partitions 8d, 18d divide part of the first opening 8a into three portions, the first portion R1, the second portion R2 and the fourth portion R4. The third portion R3 is located in the entrance opening 10c likewise as in the above-described embodiment. The fourth portion R4 is in communication with the third portion R3. The width in y direction of the fourth portion, WR4, is generally equal to the width WR1 of the first portion R1 and to the width WR2 of the second portion R2.

The specimen introduced from the entrance opening 10c flows from the third portion R3 into the first portion R1, the second portion R2 and the fourth portion R4. Since the width in the transverse direction of the first opening 8a is divided by the two partitions 8d, 18d into three parts, formation of bubbles is further suppressed.

As shown in FIG. 7E, the edge 8ac of the first opening 8a may have such a tapered shape that, in a plan view, the width on the second opening 8b side is narrower. In such a form, as compared with a case where the wall surfaces 8af, 8ag and the edge 8ac of the first opening 8a are connected at a right angle in a plan view, enclosure of bubbles at the corners is unlikely to occur. As the area of the third portion R3 decreases, the introduced specimen is allowed to flow faster into the first portion R1, the second portion R2 and the fourth portion R4.

In the above-described embodiment, the biosensor of the present disclosure has been described with an example where two types of specific substances are to be detected, although the biosensor of the present disclosure may be configured to detect only one type of specific substance. As shown in FIG. 7F, the biosensor of the present disclosure may include a spacer plate 8 which includes a first opening 8a but does not include a second opening 8b.

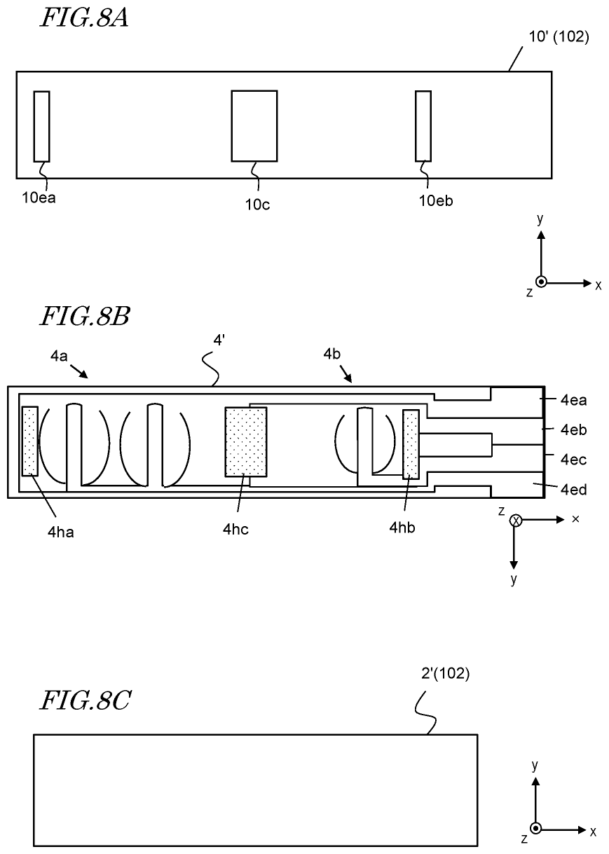

So long as the biosensor includes an electrode layer which faces the first measurement space 12a as previously described, the position of the electrode layer is not limited to the above-described embodiment. FIG. 8A, FIG. 8B and FIG. 8C are plan views of a cover plate 10′, an electrode layer 4′ and a base plate 2′, respectively, in a biosensor 102 where the electrode layer is located between the cover plate and the spacer plate. In FIG. 8B, the electrode layer 4′ is viewed from the base plate 2′ side. The electrode layer 4′ is different from the electrode layer 4 in that the electrode layer 4′ has openings 4hc, 4ha and 4hb corresponding to the entrance opening 10c, the first evacuation hole 10ea and the second evacuation hole 10eb provided in the cover plate 10′. The electrode layer 4′ is, for example, printed on a surface of the cover plate 10′ which faces the spacer plate 8 and is located between the cover plate 10′ and the spacer plate 8. Due to this configuration, the first electrode pair 4a and the second electrode pair 4b of the electrode layer 4′ face the first opening 8a and the second opening 8b of the spacer plate 8. The length in x direction of the cover plate 10′ is greater than that of the base plate 2′ such that the terminals 4ea, 4eb, 4ec, 4ed of the electrode layer 4′ are exposed.

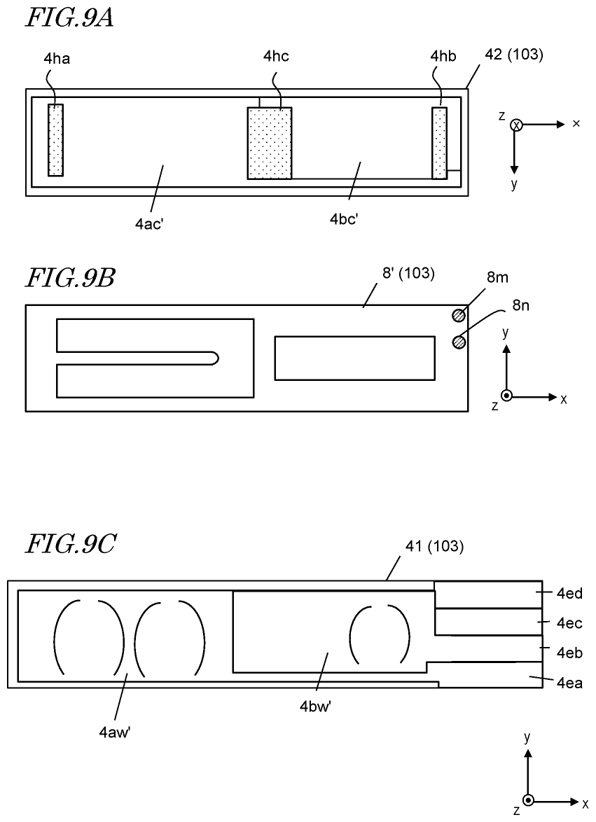

The biosensor may include two electrode layers. One of the electrode layers may include a working electrode while the other includes a counter electrode. FIG. 9A, FIG. 9B and FIG. 9C are plan views of a second electrode layer 42, a spacer plate 8′ and a first electrode layer 41 of a biosensor 103. In FIG. 9A, the second electrode layer 42 is viewed from the base plate 2 side. The first electrode layer 41 includes, for example, terminals 4ea, 4eb, 4ec, 4ed and working electrodes 4aw′, 4bw′ connected with the terminals 4ea, 4eb. The second electrode layer 42 includes counter electrodes 4ac′, 4bc′. The first electrode layer 41 is located between the base plate 2 and the spacer plate 8′. The second electrode layer 42 is located between the spacer plate 8′ and the cover plate 10.

The spacer plate 8′ includes electrically-conductive vias 8m, 8n which are respectively in contact with the counter electrodes 4ac′, 4bc′ of the second electrode layer 42 and the terminals 4ec, 4ed of the first electrode layer 41 for electrically coupling the counter electrodes 4ac′, 4bc′ and the terminals 4ec, 4ed.

In the biosensor 103 also, the working electrode 4aw and the counter electrode 4ac of the first electrode face the first measurement space 12a defined by the first opening 8a, and the working electrode 4bw and the counter electrode 4bc of the first electrode face the second measurement space 12b defined by the second opening 8b. Thus, the same effects as those of the above-described embodiment can be achieved.

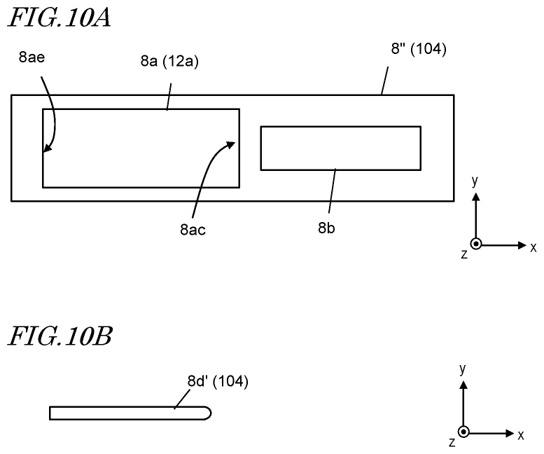

In the above-described embodiment, the partition is an integral part of the spacer plate, although the partition may be separate from the spacer plate. FIG. 10A and FIG. 10B are plan views of a spacer plate 8″ and a partition 8d′ included in a biosensor 104. The spacer plate 8″ includes a first opening 8a which defines the first measurement space 12a and a second opening 8b which defines the second measurement space 12b. The partition 8d′ is an independent constituent which is separate from the spacer plate 8″. For example, the partition 8d′ is arranged in the first opening 8a of the spacer plate 8″ so as to be in contact with the edge 8ae and is supported by the base plate 2. Even in such a form, the biosensor 104 can achieve the same effects as those of the above-described embodiment.

Although not shown, the partition 8d′ may be arranged in the first opening so as to be in contact with the edge 8ac. In this case, the partition 8d′ may be arranged such that at least part of the entrance opening 10c of the cover plate 10 overlaps two portions of the first opening 8a of the spacer plate 8″ which are divided by the partition 8d′.

Alternatively, the biosensor of the present disclosure can be embodied by appropriately combining the above-described embodiment and alternative forms. The number of openings independently provided in the spacer plate 8 is not limited to 1 or 2 but may be 3 or more. The specimen is not limited to blood or a liquid prepared by pretreating blood. The first substance and the second substance are not limited to Hb1Ac and Hb. A biosensor for detection of various substances can be realized.

### INDUSTRIAL APPLICABILITY

The biosensor of the present disclosure can be suitably used for a biosensor for use in various industrial fields including the fields of medical and clinical examinations and pharmaceutical fields.

### REFERENCE SIGNS LIST

2, 2′ base plate
4, 4′ electrode layer
4a first electrode pair
4ac counter electrode
4aw working electrode
4b second electrode pair
4bc counter electrode
4bw working electrode
4da, 4db, 4dc, 4dd wire portion
4ea, 4eb, 4ec, 4ed terminal
4ha, 4hb, 4hc opening
6A first reagent layer
6B second reagent layer
8, 8′ spacer plate
8a first opening
8ac, 8ae, 8bc, 8be, 8dc, 8de edge
8af, 8ag, 8df, 8dg wall surface
8b second opening
8d partition
8m, 8n electrically-conductive via
9 specimen
10, 10′ cover plate
10a first opening
10c entrance opening
10ea first evacuation hole
10eb second evacuation hole
11 bubble
11a first cell
11b second cell
12a first measurement space
12b second measurement space
16 sensor loading section
16a-16d connector
17 first measurement section
18 second measurement section
18d partition
19 control section
20 operation section
21 timer
22 memory section
23 temperature sensor
24 display section
30 dropper
41 first electrode layer
42 second electrode layer
101, 102, 103, 104 biosensor
201 measurement device
R1 first portion
R2 second portion
R3 third portion
R4 fourth portion
ca cut
cb cut

1. A biosensor comprising:
a base plate having a major surface;
a cover plate having an entrance section including at least one entrance opening;
a first measurement space located between the base plate and the cover plate, the first measurement space being in communication with the entrance opening of the cover plate;
at least one partition located in the first measurement space so as to divide part of the first measurement space into two or more portions;
at least one electrode layer located between the base plate or the cover plate and the first measurement space, the electrode layer including a first electrode pair including a working electrode and a counter electrode, part of the first electrode pair being located in the two or more portions of the first measurement space; and
a first reagent layer containing a first reagent capable of reacting with a specimen, the first reagent layer being located in the two or more portions of the first measurement space.

2. The biosensor of claim 1, wherein the first measurement space and the at least one partition are elongated in the first direction, and the two or more portions of the first measurement space have generally equal widths in a second direction that is perpendicular to the first direction.

3. The biosensor of claim 2, further comprising a spacer plate having a first opening which defines the first measurement space, the spacer plate being located between the base plate and the cover plate.

4. The biosensor of claim 3, wherein the at least one partition is located in the first opening of the spacer plate, one end of the partition being connected with a periphery of the first opening.

5. (canceled)

6. (canceled)

7. The biosensor of claim 3, wherein at least part of the entrance section of the cover plate overlaps another part of the first opening of the spacer plate.

8. The biosensor of claim 3, wherein at least part of the entrance section of the cover plate overlaps each of the two or more portions of the first opening of the spacer plate.

9. The biosensor of claim 3 wherein, in a plan view, the other end of the at least one partition is tapered.

10. The biosensor of claim 3 wherein, in a plan view, the other end of the at least one partition has a semicircular or curved shape.

11. The biosensor of claim 3 wherein, in a plan view, one end of the at least one partition has a curved portion in a part connecting to the periphery of the first opening.

12. The biosensor of claim 3, wherein the base plate, the spacer plate and the cover plate have a longitudinal direction in the first direction.

13. The biosensor of claim 12, wherein a length in the first direction of the at least one partition is greater than a width in the second direction of the base plate, the spacer plate and the cover plate.

14. The biosensor of claim 3, wherein
the electrode layer is a single electrode layer, and
the electrode layer is located between the base plate and the spacer plate.

15. The biosensor of claim 3, wherein
the electrode layer is a single electrode layer, and
the electrode layer is located between the cover plate and the spacer plate.

16. The biosensor of claim 3, wherein
the at least one electrode layer includes a first electrode layer and a second electrode layer,
the first electrode layer is located between the base plate and the spacer plate,
the second electrode layer is located between the cover plate and the spacer plate,
the first electrode layer includes one of the working electrode and the counter electrode, and
the second electrode layer includes the other of the working electrode and the counter electrode.

17. The biosensor of claim 3, further comprising a second reagent layer containing a second reagent capable of reacting with the specimen,
wherein the spacer plate has a second opening which is independent of the first opening and which defines a second measurement space,
the electrode layer further includes a second electrode pair including a working electrode and a counter electrode,
part of the second electrode pair is located in the second opening,
the second reagent layer is located in the second opening, and
another part of the entrance section overlaps the second opening.

18. The biosensor of claim 3, wherein the cover plate has a first evacuation hole in communication with the first opening of the spacer plate, the first evacuation hole and the entrance section being located at opposite ends in the first direction of the first opening.

19. The biosensor of claim 17, wherein
the cover plate has a first evacuation hole in communication with the first opening of the spacer plate and a second evacuation hole in communication with the second opening,
the first evacuation hole and the entrance section are located at opposite ends in the first direction of the first opening, and
the second evacuation hole and the entrance section are located at opposite ends in the first direction of the second opening.

20. The biosensor of claim 1, wherein the first reagent layer is capable of reacting with an identical substance derived from the specimen.

21. The biosensor of claim 1, wherein
the specimen includes hemoglobin separated from a red blood cell,
the hemoglobin includes hemoglobin A1c, and
the first reagent is capable of specifically reacting with the hemoglobin A1c or a substance derived from the hemoglobin A1c.

22. The biosensor of claim 3, wherein
the specimen includes hemoglobin separated from a red blood cell,
the hemoglobin includes hemoglobin A1c,
the first reagent is capable of specifically reacting with the hemoglobin A1c or a substance derived from the hemoglobin A1c, and
the second reagent is capable of reacting with the hemoglobin.
